(19) United States
(12) Patent Application Publication
(10) Pub. No.: US 2017/0095088 A1
(43) Pub. Date: Apr. 6, 2017

(54) DEVICE SYSTEM AND METHOD FOR CONTROLLING AND PROMPTING CHANGE OF SITTING POSITION

(71) Applicants: Yosef LUTWAK, Englewood, CO (US); Yonatan ZALUSKI, Denver, CO (US)

(72) Inventors: Yosef LUTWAK, Englewood, CO (US); Yonatan ZALUSKI, Denver, CO (US)

(21) Appl. No.: 14/872,189

(22) Filed: Oct. 1, 2015

(51) Int. Cl. A47C 7/56; G05B 15/02

(52) U.S. Cl. CPC A47C 7/56; G05B 15/02

(57) ABSTRACT

A tilting device for controlling a seat and prompting a change in a sitting position may include a fixed portion, connectable to a base of a chair; a movable portion connectable to a seat of the chair; a joint, positioned between the fixed portion and the movable portion configured to allow relative movement of movable portion with respect to fixed portion around at least two axes; and at least two actuators. The at least two axes may be orthogonal to each other and to an axis of the base of the chair. The device may further include a controller configured to control the operation of the at least two actuators. The device may further include at least one sensor configured to send an indication to the controller when a weight is placed on a seat of the chair. A system and a method are also described.

### FIELD OF THE INVENTION

Embodiments of the present invention relate to moveable seat modules, in particular seat modules for activating the spine in sitting position, and controlling a seat and prompting change of sitting posture or position of a user thereof.

### BACKGROUND OF THE INVENTION

In modern life, people spend a significant time of the day sitting in a still position, in many cases in a sitting position that may be harmful, or may cause discomfort, back pains, lower back muscles tightness and spasms, spinal tension or pressure on the cartilages between the vertebrae and on the vertebrae and even disc eruption and other spinal injury.

Motion to the pelvis and the vertebras may relieve such pain and reduce the probability of injury. Thus, in order to avoid such spinal related pain, discomfort and injury, it is recommended to change the sitting position from time to time, and to do some physical activity such as walking, jumping etc., and to create a movement of all the vertebras along the spinal column. However, such physical activities are not always possible, for example in work places, and people do not tend to change their still sitting position until they feel discomfort or pain.

Several devices have been disclosed in order to prevent or treat the symptoms of prolonged sitting such as a chair with a swing seat for changing the position of a person sitting thereon. Other devices provide a motored seat base for tiling in a predefined tilting scheme or arrangement a seat of a chair.

However, the known devices are limited in that they are not adaptable to each user's needs and are not programmable. Furthermore, known devices allow a limited range of movement such as along only a single axis or around a single axis with a fixed and predefined tilting angle or range. Thus, only limited activating or tilting schemes are available to a user of such devices.

### SUMMARY OF THE INVENTION

Embodiments of the present invention provide a tilting device for controlling a seat and prompting a change in a sitting position. According to some embodiments, the tilting device may include a fixed portion, connectable to a base of a chair; a movable portion connectable to a seat of the chair; a joint, positioned between the fixed portion and the movable portion configured to allow relative movement of movable portion with respect to fixed portion around at least two axes; and at least two actuators, each of the actuators connected at one end to the fixed portion and at another end to the movable portion; wherein the actuators are located in an angle with respect to each other and configured to allow tilting of the movable portion with respect to the fixed portion, around at least two axes. According to some embodiments the at least two axes are orthogonal to each other and to an axis of the base of the chair. The device according to some embodiments may further include a controller configured to control the operation of the at least two actuators. According to some embodiments the device may further include at least one sensor configured to send an indication to the controller when a weight is placed on a seat of the chair. The device may further include at least one orientation sensor, wherein the orientation sensor may be configured to interact with the controller.

According to some embodiments the at least one sensor may be at least one of: a load cell and a gyroscope. According to some embodiments the indication received from the at least one sensor may further include at least one of: the weight of an object placed on the seat and the weight distribution over the seat.

Embodiments of the present invention provide a system for controlling a seat, adjusting and/or prompting a change in a sitting position. A system according to embodiments of the present invention may include at least one chair with a tilting device, a computing device that may include at least a controller and a memory; and a server computer. The tilting device may be a tilting device as described herein, and the tilting device may be connected to the computing device to send signals from the tilting device to the controller of the computing device and to send instructions from the controller of the computing device to the actuators of the tilting device. According to some embodiments the memory of the computing device may store at least one of: tilting schemes, users' weights, users' exercise scheme preferences, and users' treatment needs.

According to some embodiments, the system may include at least one sensor, the at least one sensor may be at least one of: a load cell, a gyroscope and an accelerometer. According to some embodiments at least one sensor may be configured to send an indication to the controller when a weight is placed on a seat of the chair. The indication received from the at least one sensor may further include at least one of: the weight of an object placed on the seat, and the weight distribution over the seat.

According to some embodiments, the controller of the computing device may be configured to determine the sitting position of a user based on the weight distribution over the seat. According to some embodiments the controller may be configured to determine the identity of a user sitting on the seat, based on the received indications, for example, by comparing the indications such as the distribution of weight over the seat and the weight of the object placed on the seat, to pre-stored values of weight and weight distribution associated with one or more registered or associated users of the tilting device. A registered or associated user may be, for example, a user that completed a registration process in which the user provided identifying information, such as weight, height, name, and gender, as well as other required information such as, for example, treatment needs, scheme preferences and the like. According to one embodiment the identity of the user may be selected from a pre-stored list of users associated with the chair.

A method of controlling a seat and prompting change of a sitting position according to embodiments of the present invention may include receiving by a controller of a tilting device connected to a chair, an indication that a user is sitting on the chair, from one or more sensors; selecting a tilting scheme by the controller; and tilting the tilting device according to the selected scheme. The tilting scheme may include tilting the tilting device around at least two axes parallel to the surface on which the chair is positioned when in operational position.

According to some embodiments the method may further include determining, by the controller, at least one of: a weight of the user sitting on the chair, and a sitting position of the user sitting on the chair, based on signals received from the one or more sensors. The method may further include determining the identity of the user from a list of users of the chair stored in a memory.

The selection of the tilting scheme may be based, according to some embodiments, on at least one of: weight of a user sitting on the chair, a sitting position of the user; identity of the user and manual selection by the user. The method according to some embodiments may further include determining, by the controller, the duration the user is sitting in a first sitting position; and tilting a seat of the chair, by one or more actuators of the tilting device, to prompt the user to change his sitting position to a second sitting position.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is schematic illustration of a chair and a tilting device according to one embodiment of the present invention;

FIG. 1B is a detailed view of the tilting device of FIG. 1A according to embodiments of the present invention;

FIG. 1C is an illustration of a seat with an imaginary clock depicted on the surface of the seat for illustration of tilting schemes according to embodiments of the present invention;

FIGS. 2A, 2B and 2C are illustrations of a tilting device in different positions, according to some embodiments of the present invention;

FIGS. 3A and 3B are illustrations of the effect of tilting of a device, according to some embodiments of the present invention, on the sitting position of a user;

FIG. 4 is a high level block diagram of a system for controlling a seat and adjusting position according to some embodiments of the present invention;

FIG. 5 is a high level block diagram of an exemplary computing device according to embodiments of the present invention; and

FIG. 6 is a flowchart of a method of controlling a seat and adjusting posture according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

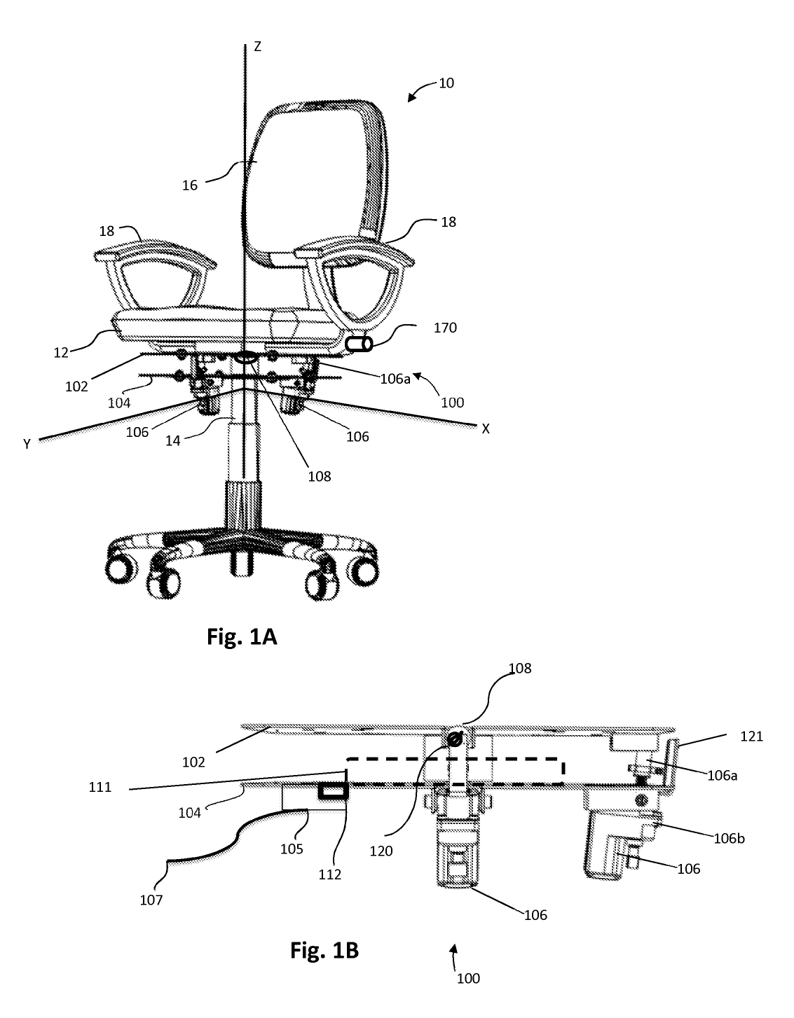

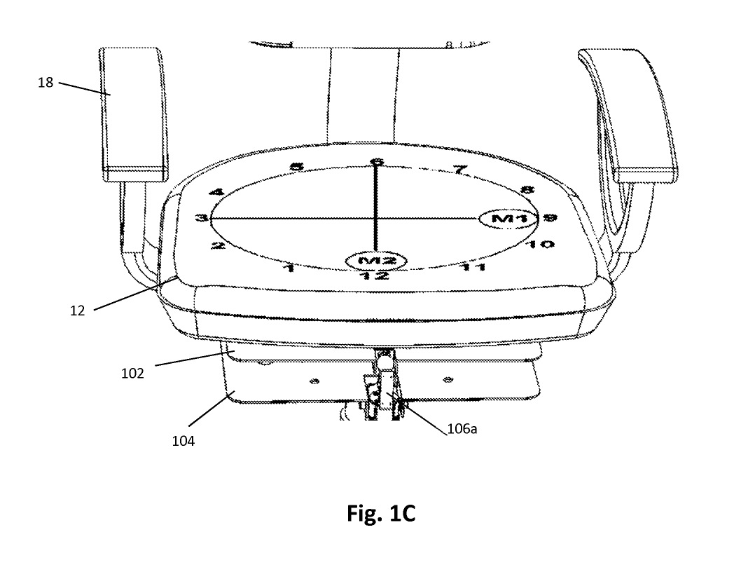

Reference is now made to FIG. 1A which is a schematic illustration of a chair 10 with a tilting device 100 according to embodiments of the present invention and to FIG. 1B which is a detailed view of tilting device 100 of FIG. 1A according to embodiments of the present invention. Tilting device 100 may include a fixed portion, such as fixed surface 104 and a movable portion, such as movable surface 102. As may be seen in FIG. 1A, according to one embodiment of the present invention, movable portion 102 may be detachably connected to seat 12 of chair 10, and fixed portion 104 may be detachably connected to a chair base, such as center post 14 of chair 10. It should be appreciated that other chair bases may be used.

According to some embodiments of the present invention, movable portion 102 may be tiltable with respect to the fixed portion 104, around a joint 108 configured to allow movement of movable portion 102 around at least two axes. Joint 108, may be positioned, according to one embodiment, between fixed portion 104 and movable portion 102, and substantially in the center of both fixed portion 104 and movable portion 102, for example, along a longitudinal axis Z of center post 14. According to some embodiments joint 108 may be a spherical joint.

Joint 108 may be designed to allow movement of movable portion 102 with respect to fixed portion 104 around at least two orthogonal imaginary axes X and Y which are parallel to the surface of movable portion 102 and run through joint 108. Axes X and Y may also be orthogonal to longitudinal axis Z of chair base, such as central post 14.

As may be seen in FIGS. 1A and 1B, tilting device 100 may include two or more actuators 206A, 206B connected to movable portion 102 and to fixed portion 104. According to one embodiment of the present invention, each one of actuators 206A, 206B may be connected to movable portion 102 via an arm 106a. According to one embodiment actuators 206A, 206B and/or arms 106a may be connected to movable portion 102 in an angle of 90 degrees about joint 108, around the Z axis between actuators 206A, 206B or arms 106a. According to another embodiment the angle between actuators 206A, 206B and/or arms 106a may be 120 degrees. It should be appreciated that other relative angles may be used. According to some embodiments, each actuator 206 may be configured to tilt movable portion 102 around one axis X or Y.

As may be seen in FIG. 1B, tilting device 100 may further include one or more sensors 120. Each of sensors 120 may be for example a gyroscope with an accelerometer board, a load cell, or any other sensor known in the art, that is suitable for or configured to provide an indication to controller 105, when pressure or movement is applied to one or more of sensors 120. For example, according to one embodiment, one or more sensors 120 may provide signals (e.g., to controller 105) that may indicate that a user is sitting on seat 12, and the weight of the user sitting on seat 12. According to some embodiments, the signals received from each sensor 120 may indicate the weight distribution of the user over the seat and may thus be used in order to determine the users sitting posture or position. For example, when a user is sitting on seat 12 leaning towards one side, e.g. to the right, the pressure sensed by a sensor 120 located on that side of the seat would indicate higher pressure than the sensor on the left, while when the user is sitting in an upright position the measurements by sensors 120 on both sides of seat 12, would provide substantially identical or very close measurements.

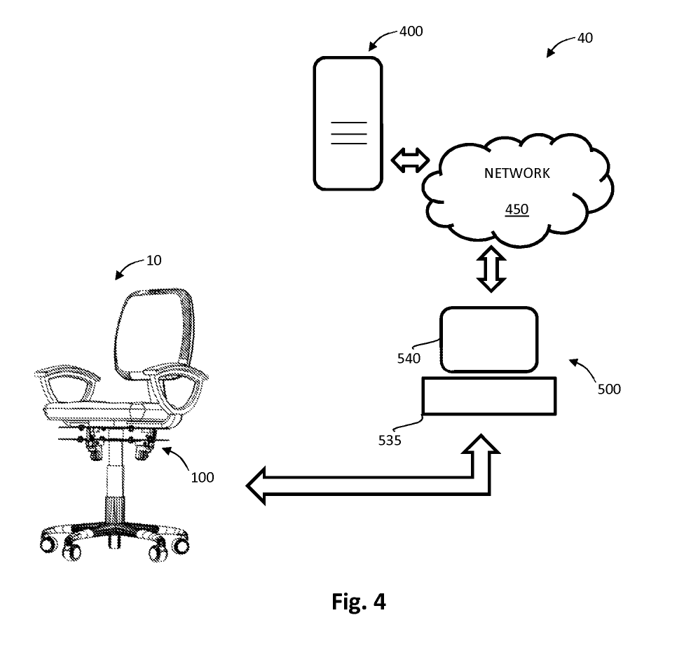

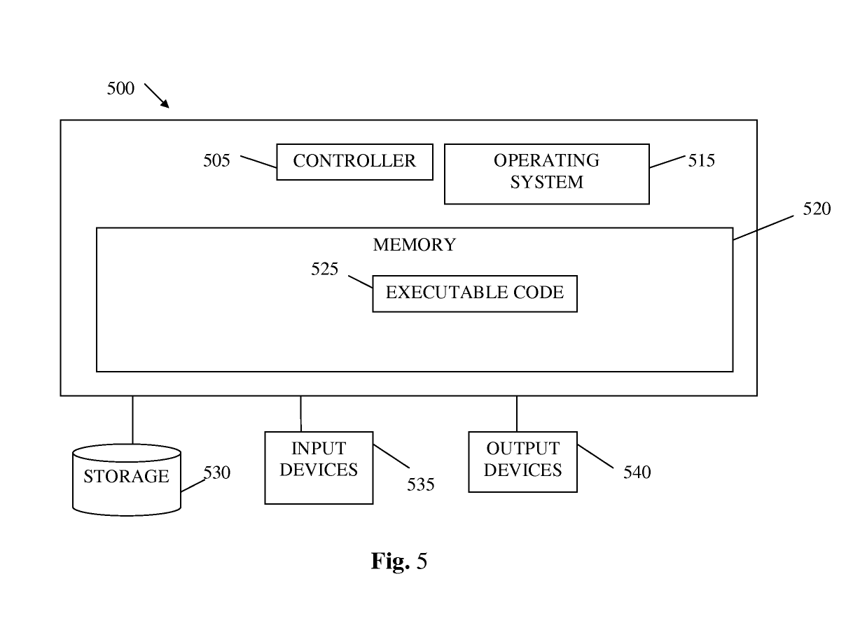

According to another example, when one or more of sensors 120 are a gyroscope with an accelerometer, a signal received from sensor 120 may be indicative of the sitting position of a user, regardless of the location of the gyroscope and accelerometer. The indications received from sensors 120 at controller 105 may be used in order to control operation of tilting device 100 (e.g. start tilting scheme when a user is sited and stop when a user stands up), determine the appropriate tilting scheme, for example, when the signals received from sensors 120 indicate that a user is sitting leaning to the left for more than a predefined time period, such as for example, over 10 minutes. In situation such as described a tilting scheme may be initiated and adapted to tilt the seat to the right so that the user would be prompted to change his sitting position. It should be appreciated that a user may set or provide inputs to tilting device 100 and/or system 40 (in FIG. 4) not to prompt change of sitting position in such scenarios, or even to determine in which specific cases to prompt a position change and in which cases not to prompt such change. Setting or providing input may be done via a user interface of computing device 500 (e.g., FIGS. 4 and 5). In another example, the weight distribution between different sensors 120 may indicate that the user is leaning backwards on backrest 16 or having one of his arms or both arms resting on armrests 18. A tilting scheme, sequence, movement sequence, or arrangement may include one or more sets of information describing the position of the various components of the chair, and possibly when, how, and how fast to move the components from one set of positions to another. When used herein, a tilting scheme, sequence, movement sequence, or arrangement may be the actual physical movements of the components and also may be the data or instructions that cause such movements.

According to some embodiments, signals received from sensors 120 may indicate the user's weight and/or weight distribution. Accordingly, tilting speed may be adjusted for example by controlling the power supplied to actuators 206A, 206B and thus control the speed of actuators 206A, 206B based on the user's weight distribution.

According to some embodiments, the tilting speed may be kept substantially constant throughout an exercise scheme or treatment cycle. The tilting speed may be maintained slow, such as, for example, no more than 3 millimeters (mm) per second, or in terms of angular velocity no more than 3.0/R radians per second, where R is the edge of the apparatus' distance from the center of tilting (e.g. the edge of movable portion 102 from joint 108). While it should be appreciated that when an exercise scheme or treatment cycle is initiated and ended some acceleration and deceleration are required, it may be a very slow linear acceleration and deceleration, such as, for example an acceleration or deceleration of no more than 3 mm/s², or even 2 mm/s², an equivalent of 3.0/R radians/s² or 2.0/R radians/s² of angular acceleration, respectively, where R is as defined above. Other speeds and accelerations may be used. This may allow the user's body to get adapted and organized to the changes in the lower body, and may create and maintain calm and safe environment so the movement is predictable and repeatable for the brain. Furthermore, such substantially constant speed may ensure better adaptation toward natural body movement, may decrease or eliminate interferences to the work or any other activity the user may be doing while sited, may reduce resistance of the body (muscles) to the movement and thus, may reduce muscles tension and the like. It should be further appreciated that the slow and controlled acceleration/deceleration may prevent or reduce mechanical damage to the actuators and other moving parts. For example, according to some embodiments of the present invention a typical linear tilting movement may have the following time duration characteristics: 1.5 seconds acceleration of 1-2 mm/s², 2 seconds constant speed of 1.5-3 mm/s, 1.5 seconds deceleration of 1-2 mm/s² Other characteristics may be used.

It should be further appreciated that the user's weight indication may be used by controller 105 of device 100 and/or by controller 505 of computing device 500 (e.g. FIG. 5) to determine the identity of the user, from a list of users associated with chair 10, and thus adapt the tilting scheme to the needs, preferences, and characteristics of each identified user. According to another embodiment, a user may logon for example via input device (e.g., 535 in FIG. 5) of computing device 500. According to yet another embodiment, when weight based identification is inapplicable, for example when the measured weight is associated with more than one user, or with no user, the user may be requested by computing device 500 to identify himself. Such identification request may be presented on output device 540 of computing device 500, such as a monitor or a screen. It should be appreciated that the needs, preferences and characteristics of each user of tilting device 100 may be pre-obtained and pre-stored in storage (such as storage 530 of computing device 500 in FIG. 5 and/or of server 400 of system 40 in FIG. 4). According to some embodiments, a memory or storage may be integral to controller 105 of tilting device 100.

According to some embodiments, tilting device 100 may include positioning or orientation sensors 121, such as, for example, a gyroscope or potentiometer, to provide controller 105 with feedback regarding the position, orientation and/or angle of movable portion 102. It should be appreciated that the amplitude and angle of tilting of movable portion 102 may be limited within a predefined range such as for example 5° in each direction around each axes X and Y. According to some embodiments, the range of the tilting angle may be different around each axis. For example, the maximum tilting angle around the X axis may be, for example ±5° while around the Y axis the maximum tilting angle may be ±20°. According to other embodiments, a different tilting range may be set to each direction of tilting around a single axis. For example, around the Y axis, when tilting seat 12 forward the maximum tilting angle may be 10° while when tilting seat 12 backwards around axis y, the maximum tilting angle may be 20°. It should be appreciated that other tilting angle limits or ranges may be used. Orientation sensor or sensors 121 may indicate, according to some embodiments, when the position of movable portion 102 reaches a limit and may cause controller 105 to stop actuators 206A, 206B. According to some embodiments, tilting device 100 may further include limit switches in addition to or instead of orientation sensor 121. It should be appreciated that the limit switch or switches may stop operation of one or more actuators 206A, 206B when the maximum tilting angle is reached. It should be appreciated that limit switch or switches may protect actuators 206A, 206B from electrical current or mechanical overload. According to some embodiments, tilting device 100 may further include a power cord 107, a power source such as battery 111, and a communication inlet or port such as a USB connection port 112.

According to some embodiments, a safety or emergency stop button or switch 170 (in FIG. 1A) may be connected to controller 105, via wired or wireless connection, and may be configured to stop operation of tilting device 100.

As may be seen in FIG. 1B, actuators 206A and 206B may have a motor and gear section 106b and an arm 106a. Arm 106a may be a piston, a screw or any other mechanism that may change the distance between a first end of the mechanism and a second end thereof. Other structures may be used for actuators.

It should be appreciated by those skilled in the art, that tilting device 100 according to embodiments of the present invention, allows tilting movable portion 102 around two axis X and Y, and thus provides for tilting of seat 12 forward, backward, sideways and to any direction in-between. For example, if seat 12 is marked, for illustration purposes, with an imaginary clock as seen in FIG. 1C, so that the hour 12 is at the front of the seat, the hour 6 is at the back of the seat (proximal to the seat backrest) the hour 3 is at the right side of the seat (proximal to the right armrest 18) and the hour 9 is on the left side of seat 12, and actuator 206A is located, for example, at the hour 12 while actuator 206B is located, for example, at the hour 9, tilting movable portion 102, and thus seat 12, for example, forward, to the hour 12, refers to a position of movable portion 102 in which the hour 12 is at a lowered position, e.g. actuator 206A is contracted (e.g. arm 106a is contracted) and actuator 206B is idle. Similarly, when movable portion 102 is tilted to the hour 9 (so that the lower point of movable portion 102 is at the left side of movable portion 102), actuator 206B is contracted and actuator 206A is idle. It should be appreciated that the above tilting device allows tilting movable portion 102 towards any imaginary hour of the imaginary clock by a combination of extraction and/or contraction of actuators 206A and 206B located, for example at the front of movable portion 102 and the left side of movable portion 102. For example, tilting movable portion 102 towards the hour 1:30 may be achieved by contracting actuator 206A and extracting actuator 206B. As may be understood, according to embodiments of the present invention, a full circular motion may be achieved (clockwise or counter-clockwise) by changing the extraction and/or contraction of each of actuators 206A, 206B in a coordinated manner According to some tilting schemes, only an arc tilting scheme (for example from hour 3 to 9 through 12 and vice versa, from 1 to 11 through 12, from 5 to 7 through 6 and the like) may be programmed and used in some cases. According to another scheme, a linear tilting scheme may be used. A linear tilting scheme is a scheme in which movable portion 102 tilts from a first position (e.g. from the hour 3) to a second position (e.g. to the hour 9) directly, around an axis perpendicular to a line connecting the imaginary hours on the face of the imaginary clock. It should be appreciated that according to some embodiments, a tilting scheme may be a combination of arc, circular and linear tilting movements.

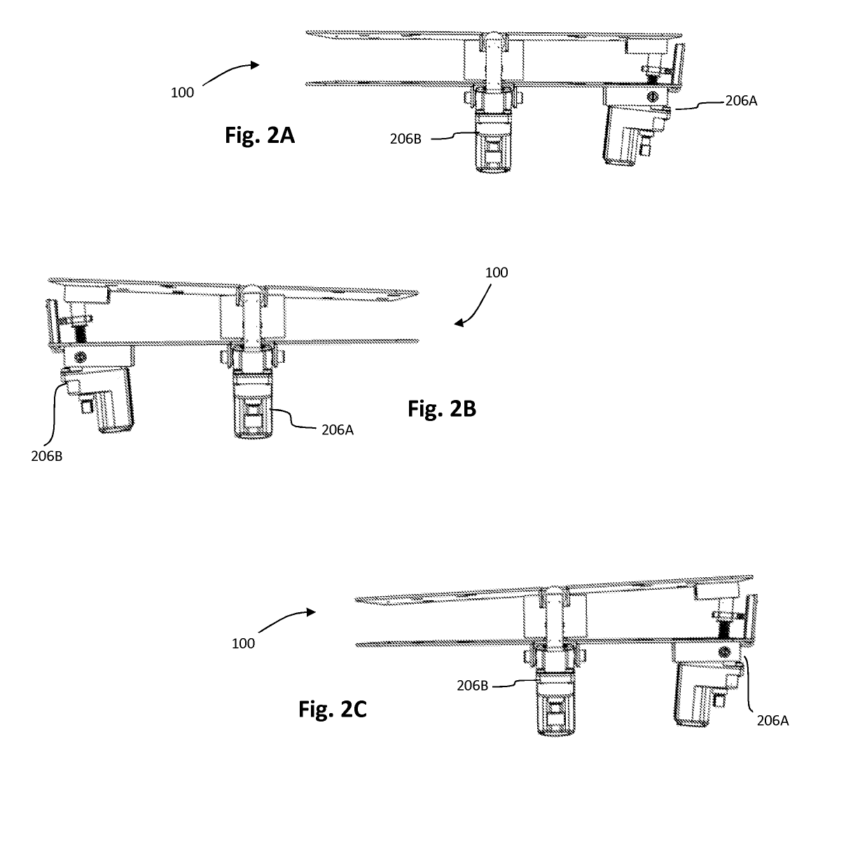

Reference is now made to FIGS. 2A, 2B and 2C illustrating tilting device 100 in different positions. As seen in FIG. 2A tilting device 100 may be in a neutral position (e.g. in a position substantially parallel to the surface on which a chair to which the tilting device is connected, is positioned) when all actuators 206, such as for example, actuators 206A and 206B are idle. In FIG. 2B actuator 206B is extracted while actuator 206A is idle. FIG. 2C shows tilting device 100 in another tilting position in which actuator 206A is extracted and actuator 206B is idle, thus a different position of movable portion 102 relative to fixed portion 104 may be reached. It should be appreciated that other combinations of extraction or contraction of at least actuators 206A and 206B, may result in other tilting position of movable portion 102 with respect to fixed portion 104. A tilting scheme, sequence, movement sequence, or arrangement may include one or more sets of information describing the position of the various components of the chair, and possibly when, how, and how fast to move the components from one set of positions to another. When used herein, a tilting scheme, sequence, movement sequence, or arrangement may be the actual physical movements of the components and also may be the data or instructions that cause such movements. According to embodiments of the present invention, a tilting scheme may include for example a sequence of instructions to controller (e.g. 105 in FIG. 1A) to move, extract and/or contract actuators, motors, servos, latches, etc., at least one of actuators 206A and 206B. For example, a sequence of instructions to controller 105 for example, to repeatedly extract and contract actuator 206A while maintaining actuator 206B idle, may result in a linear tilting scheme. A different sequence of instructions to extract and/or contract one or more of actuators 206A and 206B may result in different tilting schemes as described herein.

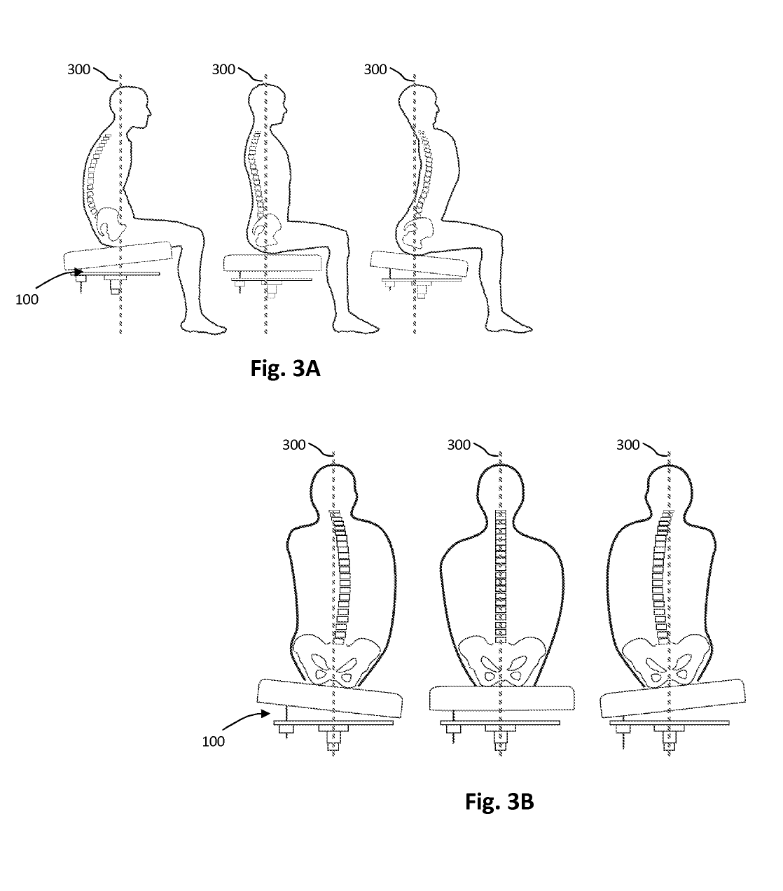

FIGS. 3A and 3B are illustrations of the effect of tilting of tilting device 100, according to some embodiments of the present invention, on the sitting position and spinal movement of a user. As seen in FIGS. 3A and 3B, tilting of tilting device 100 may cause a user to curve his or her back around user's body midline 300.

Body's midline 300 is an imaginary line that divides the body into halves. It is known that the brain and the Central Nerve System (CNS) organize the body subconsciously around midline 300 to keep it balanced. However, the modern life style (primarily sitting for long time periods), injuries, pain, etc. causes the brain and the CNS to “lose” this natural ability to a certain degree. Thus it should be appreciated by those skilled in the art that slow and graduate tilting of the pelvis, may prompt a user of tilting device 100 to gradually organize his body around the natural midline 300, and may move all 24 vertebrae of the spine.

As seen in FIG. 3A, which includes three side view illustrations, tilting movable portion 102 of tilting device 100 forward, as seen in illustration (3) may cause a user to curve his back backwards (e.g. to arch his or her back), neutral position of movable portion 102 prompts the user to sit in an upright position, as illustrated in illustration (2), and tilting movable portion 102 backwards (as seen in illustration (1)), may prompt the user to curve his or her back forward (e.g. to a humped position). As may be seen in illustration (1) on the left side of FIG. 3A the back side of the seat is tilted down, causing the body to round (from the back's viewpoint) along the spine, counter-balancing the backward tilting of the pelvis; on the center of FIG. 3A (illustration (2)) the seat is leveled horizontally, the spine remains in its upright position; on the right side of FIG. 3A (illustration (3)) the front side of the seat is tilted down, causing the body to arch along the spine counter-balancing the forward tilting of the pelvis. Similarly, as seen in FIG. 3B, different tilting position of movable portion 102 may prompt a user to curve his or her back to the right or to the left.

As seen on the left side of FIG. 3B (illustration (1)), which is a back view of a user of tilting device 100, the left side of the seat is tilted up, causing the pelvis to tilt to the right toward a side-bending, and the body responds along the spine by counter-balancing the side-bending tilting of the pelvis by creating a ‘C’-like curve to the right; on the center of FIG. 3B (illustration (2)) the seat is leveled horizontally, the spine remains in its upright position; on the right side of FIG. 3B (illustration (3)) the right side of the seat is tilted up, causing the pelvis to tilt to the left toward a side-bending, and the body responds along the spine by counter-balancing the side-bending tilting of the pelvis by creating a ‘C’ curve to the left. Other tilting positions may prompt the user to change his sitting position in other directions.

Reference is now made to FIG. 4 which is a high level block diagram of a system 40 for controlling a seat and prompting change in sitting position according to some embodiments of the present invention. System 40 may include at least one chair 10 with a tilting device 100, tilting device 100 may be in active communication with computing device 500 as described herein with respect to FIG. 5, such as a desktop computer, a laptop computer, a tablet, a smartphone, a handheld wireless or wired control unit, and the like. Computing device 500 may, according to some embodiments, communicate with a remote server 400, such as a cloud server, via a network 450 such as the Internet. Server 400 may be a computing device as described with reference to FIG. 5 herein. While computing device 500 and server 400 are illustrated as separate devices, according to some embodiments, tilting device 100 may be in communication with a remote computing device via a network, and computing device 500 may be a cloud server

According to some embodiments, computing device 500 may include an output device 540, such as a display or a screen. According to some embodiments, animation may be presented to the user on output device 540 to show the effect the tilting scheme may have on the user's spine, sitting position and the like. Computing device 500 may further include input device(s) 535 to allow the user to manually control and change setting of system 40. For example, a user may program the neutral position (which may define, in some embodiments, a starting position) of tilting device 100, and/or create a tilting scheme according to the user's preferences and/or according to a prescribed scheme provided by a therapist (e.g. physiotherapist). In addition, or alternatively, a user may provide, via, for example input device 535, identifying information to allow system 40 to identify the user, from a list of predefined users associated with chair 10. A tilting scheme may include definitions of the extent of the tilting angles on both axes of titling and both ends of movement, the relative timing of change of each angle of tilting, the duration of activation of the scheme, and the like.

Reference is made to FIG. 5, showing a high level block diagram of an exemplary computing device according to embodiments of the present invention. Computing device 500 may include a controller 505 that may be, for example, a central processing unit processor (CPU), a chip or any suitable computing or computational device, an operating system 515, a memory 520, an executable code 525, a storage 530, input devices 535 and output devices 540. Controller 505 may be configured to carry out methods described herein, and/or to execute or act as the various modules, units, etc. More than one computing device 500 may be included, and one or more computing devices 500 may act as the various components, for example some components shown in FIG. 4. For example, the server described herein may be, or may include components of, computing device 500. For example, by executing executable code 525 stored in memory 520, controller 505 may be configured to carry out a method of controlling a seat and adjusting sitting position as described herein. For example, controller 505 may be configured to receive signals from one or more sensors 120 in tilting device 100 in FIG. 1A and use the received signals to control the operation of tilting device 100 as described herein.

Operating system 515 may be or may include any code segment (e.g., one similar to executable code 525 described herein) designed and/or configured to perform tasks involving coordination, scheduling, arbitration, supervising, controlling or otherwise managing operation of computing device 500, for example, scheduling execution of software programs or enabling software programs or other modules or units to communicate. Operating system 515 may be a commercial operating system.

Memory 520 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 520 may be or may include a plurality of, possibly different memory units. Memory 520 may be a computer or processor non-transitory readable medium, or a computer non-transitory storage medium, e.g., a RAM.

Executable code 525 may be any executable code, e.g., an application, a program, a process, task or script. Executable code 525 may be executed by controller 505 possibly under control of operating system 515. For example, executable code 525 may be an application that determines the posture of a user sitting on seat 10 (in FIG. 1A) based on input received from one or more sensors of tilting device 100 (in FIG. 1B), select a tilting scheme, based on, for example, the input received from the one or more sensors and the identity of a user sitting on seat 10, and/or based on an input received from a user, and send instructions to tilting device 100 to change tilt of seat according to the selected scheme for example as described herein. Although, for the sake of clarity, a single item of executable code 525 is shown in FIG. 5, a system according to embodiments of the invention may include a plurality of executable code segments similar to executable code 525 that may be loaded into memory 520 and cause controller 505 to carry out methods described herein. For example, units or modules described herein (e.g., tilting device 100) may be, or may include, controller 505 and executable code 525.

Storage 530 may be or may include, for example, a hard disk drive, a floppy disk drive, a Compact Disk (CD) drive, a CD-Recordable (CD-R) drive, a Blu-ray disk (BD), a universal serial bus (USB) device, Flash memory or other suitable removable and/or fixed storage or memory unit. In some embodiments, some of the components shown in FIG. 5 may be omitted. For example, memory 520 may be a non-volatile memory having the storage capacity of storage 530. Accordingly, although shown as a separate component, storage 530 may be embedded or included in memory 520. Memory 520 and/or storage 530 may store, according to some embodiments, at least one of: tilting schemes, users' weights, users' exercise scheme preferences, users' treatment needs, users' identification information and the like.

Input devices 535 may be or may include a mouse, a keyboard, a touch screen or pad, sensors or any suitable input device. It will be recognized that any suitable number of input devices may be operatively connected to computing device 500 as shown by block 535. Output devices 540 may include one or more displays or monitors, speakers and/or any other suitable output devices. It will be recognized that any suitable number of output devices may be operatively connected to computing device 500 as shown by block 540. Any applicable input/output (I/O) devices may be connected to computing device 500 as shown by blocks 535 and 540. For example, a wired or wireless network interface card (NIC), a printer, a universal serial bus (USB) device or external hard drive may be included in input devices 535 and/or output devices 540.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 520, computer-executable instructions such as executable code 525 and a controller such as controller 505.

The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 520 is a non-transitory machine-readable medium.

A system according to embodiments of the invention may include components such as, but not limited to, a plurality of central processing units (CPU) or any other suitable multi-purpose or specific processors or controllers (e.g., controllers similar to controller 505), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more devices such as computing device 500 and tilting device 100.

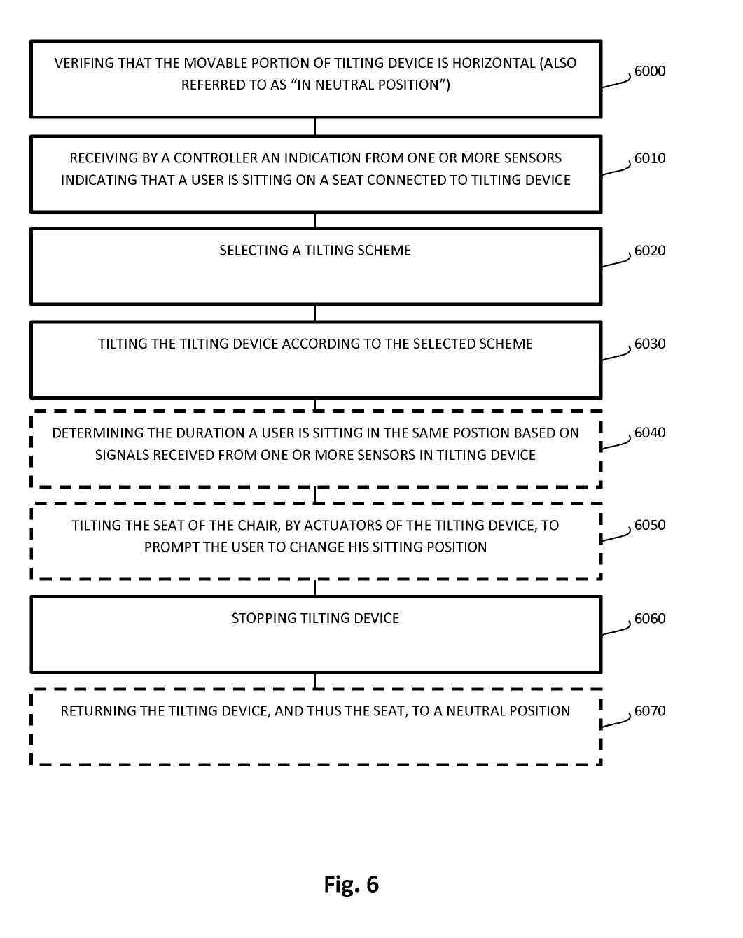

Reference is now made to FIG. 6 which is a flowchart of a method of controlling a seat and prompting change of sitting position according to one embodiment of the present invention. As may be seen in block 6000, when the tilting device is turned on, a controller of the tilting device (that may be integral to the tilting device or may be part of a computing device associated with the tilting device) may verify that the movable portion of the tilting device is horizontal (also referred to as “in neutral position”), e.g. that the movable portion of tilting device is parallel to the surface on which a chair to which the tilting device is connected, is positioned. According to some embodiments, the neutral position may be programmed by a user to be different from the horizontal position.

As seen in block 6010 a signal may be received by a controller of a tilting device, such as the tilting device described above, from one or more sensors, such as load cells, indicating that a user is sitting on a chair such as chair 10 in FIG. 1A. According to some embodiments, the controller of the tilting device or the controller of a computing device to which the tilting device is connected or in communication with, may determine the weight of the user sitting on the chair, the sitting posture of the user, for example, based on signals received from two or more sensors, and according to some embodiments the identity of the user from a list of users of the chair stored in a memory. According to some embodiments the identity of the user may be determined for example, based on the weight of the user indicated by the sensors, the sitting posture of the user received from the sensors and the like, and based on a comparison of the indications received from the sensors to pre-stored data associated with each registered user, such as each registered user's weight, and each registered user's weight distribution over the seat when the seat is in a neutral position. In some embodiments the identity may be determined by comparing the indications received from the sensors to the pre-stored data of a list of registered users. A registered or associated user may be, for example, a user that completed a registration process in which the user provided identifying information, such as for example weight, height, name, gender, and the like, or other information. The registration process may include receiving for example via one or more input device (e.g. 535 in FIG. 5) and storing in storage (e.g. 530 in FIG. 5) identification information. The information may include, according to some embodiments, name, weight, height, weight distribution over the seat when the tilting device is in a neutral position, gender, and the like, or other information. Some of the information may be received from a user providing the information via a keyboard, a touchscreen or any other input device. Other identification data may be received from the sensors of the tilting device during registration process, for example the distribution of weight over the seat during the registration process, when the seat is in a neutral position.

After receiving an indication that a user is sitting on the chair, and in some embodiments after the weight, posture, and/or identity of the user is determined by the controller, the controller of either the tilting device or of the computing device may select a tilting scheme, for example, based on the determined sitting posture of the user and/or based on pre-stored program requirements or preferences of an identified user (block 6020), and start tilting the tilting device according to the selected scheme (block 6030). It should be appreciated that a user may select a scheme manually through an input device, such as a keyboard, a touchscreen, or any other input device of the computing device described with reference to FIG. 5 above, or of the tilting device. For example, according to one embodiment, the computing device may be a smartphone which may be in active communication with the tilting device via, for example, Bluetooth or any other short-range wireless communication protocols, or via, for example, wired communication, and the user may provide his selection of a scheme manually through a dedicated application on the smartphone.

According to one embodiment of a method according to the present invention, the method may further include determining, by the controller, the duration a user is sitting in the same posture based on signals received from one or more sensors in tilting device (block 6040) and tilting the seat of the chair, by actuators of tilting device, to prompt the user to change his sitting position (block 6050).

According to some embodiments, after a tilting scheme has ended (e.g. a predefined number of repetitions of a tilting movements has been completed, such as for example 15 cycles of tilting the seat of the chair backwards and forwards, around the X axis in FIG. 1A), the tilting may be stopped (block 6060). According to some embodiments, when a tilting scheme has been completed, the user may select via the input device another scheme. According to some embodiments, a user may stop a scheme while the scheme is running by pressing a stop button, a safety break or the like. In some embodiments, the user may select to tilt the seat to a specific tilt position via an input device, such as via the user interface of an application on the user's smartphone, tablet, computer and the like.

According to yet another embodiment, the controller may present on an output device, such as a touchscreen of a smartphone, a display of a computer and the like, one or more proposed tilting schemes, arrangements, or movement sequences for the user to select from. According to some embodiments, the proposed schemes may be presented if no selection was received from the user within a predefined time period from the end of the previous scheme.

According to some embodiments, as seen in block 6070, each tilting session may end with returning the tilting device, and thus the seat, to a neutral position, for example a position in which the movable portion of the tilting device, and thus the seat, are parallel or substantially parallel to the surface on which the chair is positioned. According to some embodiments, a minimum rest time may be set, preventing a user from starting a new tilting session before a predefined rest time has elapsed since the end of the previous session ended. The rest time may be for example a 1 minute rest time, a 5 minute rest time or any other predefined rest time. It should be appreciated that the duration of the rest time may be determined by the controller according to the identity of the user, the user's weight, user's exercise scheme preferences, and user's treatment needs.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A tilting device for controlling a seat and prompting a change in a sitting position comprising:
a fixed portion, connectable to a base of a chair;
a movable portion connectable to a seat of the chair;
a joint; positioned between the fixed portion and the movable portion configured to allow relative movement of movable portion with respect to fixed portion around at at least two axes;
at least two actuators, each of the actuators connected at one end to the fixed portion and at another end to the movable portion;
wherein the actuators are located in an angle with respect to each other about the joint and configured to allow tilting of the movable portion with respect to the fixed portion, around at least two different axes.

2. The device according to claim 1, wherein the at least two axes are orthogonal to each other and to a vertical axis of the base of the chair.

3. The device according to claim 1 further comprising a controller configured to control the operation of the at least two actuators.

4. The device according to claim 3 further comprising at least one sensor configured to send an indication to the controller when a weight is placed on a seat of the chair.

5. The device according to claim 3 further comprising at least one orientation sensor, wherein the orientation sensor, wherein the orientation sensor is in active communication with the controller.

6. The device according to claim 4 wherein the at least one sensor is at least one of: a load cell and a gyroscope.

7. The device according to claim 6 wherein the indication received from the at least one sensor further comprises at least one of: a weight is placed on the seat, the weight of an object placed on the seat, and the distribution of the weight over the seat.

8. A system for controlling a seat and adjusting a sitting position comprising:
at least one chair with a tilting device; and
a computing device comprising at least a controller and a memory;
wherein the tilting device comprises:
a fixed portion, connectable to a chair base;
a movable portion connectable to a seat of the chair;
an at least one joint; positioned between the fixed portion and the movable portion; and
at least two actuators, each of the actuators connected at one end to the fixed portion and at another end to the movable portion;
wherein the actuators are located in an angle with respect to each other and configured to allow tilting of the movable portion with respect to the fixed portion, around at least two axes, and
wherein the tilting device is connected to the computing device to send signals from tilting device to the controller of computing device and to send instructions from the controller of the computing device to the actuators of the tilting device.

9. The system according to claim 8 wherein the memory of the computing device stores at least one of: tilting schemes, users' weights, users' exercise scheme preferences, and users' treatment needs.

10. The system according to claim 8, wherein the at least two axes are orthogonal to each other and to a longitudinal axis of the chair base.

11. The system according to claim 8 further comprising at least one sensor.

12. The system according to claim 11 wherein the at least one sensor is at least one of: a load cell, a gyroscope and an accelerometer, and wherein the at least one sensor is configured to send an indication to the controller when a weight is placed on a seat of the chair.

13. The system according to claim 12 wherein the indication received from the at least one sensor further comprises at least one of: the weight placed on the seat, and the weight distribution over the seat.

14. The system according to claim 13 wherein the controller of the computing device is configured to determine the sitting position of a user based on the weight distribution over the seat.

15. The system according to claim 12 wherein the controller is configured to determine the identity of a user sitting on the seat, based on the received indications.

16. The system according to claim 15 wherein the identity of the user is selected from a pre-stored list of users associated with the chair.

17. A method of controlling a seat and prompting change of sitting position, comprising:
receiving by a controller of a tilting device connected to a chair, an indication that a user is sitting on the chair, from one or more sensors;
selecting a tilting scheme by the controller; and
tilting the tilting device according to the selected scheme,
wherein the tilting scheme comprises tilting the tilting device around at least two axes parallel to the surface on which the chair is positioned when in operational position.

18. The method according to claim 17 further comprising:
determining, by the controller, at least one of: a weight of the user sitting on the chair, and a sitting position of the user sitting on the chair, based on signals received from the one or more sensors.

19. The method according to claim 18 further comprising determining the identity of the user from a list of users of the chair stored in a memory.

20. The method according to claim 17 wherein the selection of the tilting scheme is based on at least one of: weight of a user sitting on the chair, a sitting position of the user; identity of the user and manual selection by the user.

21. The method according to claim 17 further comprising:
determining, by the controller, the duration the user is sitting in a first sitting position; and
tilting a seat of the chair, by one or more actuators of the tilting device, to prompt the user to change his sitting position to a second sitting position.
